(19) United States
(12) Patent Application Publication
(10) Pub. No.: US 2023/0325444 A1
(43) Pub. Date: Oct. 12, 2023

(54) MULTI-ACCESS POINT ITEM DATA EXTRACTION AND MANAGEMENT COMPUTING SYSTEM

(71) Applicant: The Catalogue Project, Boston, MA (US)

(72) Inventors: Renée S. Moussa, Boston, MA (US); Patricia M. Healy, Phoenix, AZ (US)

(73) Assignee: The Catalogue Project, Boston, MA (US)

(21) Appl. No.: 18/193,541

(22) Filed: Mar. 30, 2023

Related U.S. Application Data
(60) Provisional application No. 63/326,092, filed on Mar. 31, 2022.

(51) Int. Cl. G06F 16/951; G06F 16/25; G06F 16/245

(52) U.S. Cl. CPC G06F 16/951; G06F 16/245; G06F 16/258

(57) ABSTRACT

A method includes identifying by an item data extraction and management computing entity of a multi-access point item data extraction and management system one or more active item data access points of a computing device. The method further includes whether to extract item data from the one or more active item data access points. When it is determined to extract the item data, the method further includes identifying relevant item data available from the one or more active data access points, extracting the relevant item data from the one or more active data access points, parsing the relevant item data to produce parsed item data, analyzing the parsed item data to produce interpreted item data, and storing one or more of the relevant, parsed, and interpreted item data in one or more databases of the multi-access point item data extraction and management system.

### CROSS-REFERENCE TO RELATED APPLICATIONS

The present U.S. Utility Pat. Application claims priority pursuant to 35 USC § 119(e) to U.S. Provisional Application Serial Number 63/326,092, filed Mar. 31, 2022, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to data extraction and more particularly to a database system with smart multi-access point item data extraction.

### Description of Related Art

Metadata is a structured way to communicate information about a data set. In the context of ecommerce websites, metadata describes unseen HyperText Markup Language (HTML) elements that directly communicate and clarify website information (e.g., for search engines). These micro-communications may include page titles, description tags, protocols, purposes, characteristics, general content, etc. Metadata gives certain applications such as search engines the ability to categorize and contextualize data.

A web crawler is an artificial intelligence algorithm that browses the internet to search for data. A web scraper is a tool that extracts data from a website. Web scrapers can extract all the data on a particular site or specific data identified by a user. Generally, when a web scraper needs to scrape a site, first the uniform resource locators (URLs) are provided, then it loads the HTML code for those sites. Advanced scrapers might extract all the Cascading Style Sheet (CSS) and Javascript elements as well. The web scraper then obtains the required data from this HTML code and outputs this data in a specified format (e.g., an Excel spreadsheet). Search engines use web crawling and scraping to collect data and provide relevant links in response to user search engine queries. Indexing primarily focuses on the text on a web page and the metadata about the web page that users do not see.

A virtual closet application is an application that helps organize and plan a wardrobe. It stores clothing images and information for a user and may recommend or otherwise allow for item combination generation. A typical virtual closet application requires a user to bulk upload images of clothing and/or accessories into the application with minimal image processing (e.g., background removal, etc.). This method is time consuming and requires frequent updating. Some applications include a generic database of items to add to your wardrobe to lessen the burden of manual upload. However, these items may not accurately match the items in your actual wardrobe. Further, virtual closet applications are limited to clothing and accessories and do not take into account other items such as home goods.

### BRIEF DESCRIPTION OF THE SEVERAL VIEWS OF THE DRAWING(S)

FIG. 1 is a schematic block diagram of an embodiment of a multi-access point item data extraction and management computing system;

FIGS. 2A-2E are schematic block diagrams of embodiments of computing entities that form at least part of a multi-access point item data extraction and management computing system;

FIGS. 3A-3E are schematic block diagrams of embodiments of computing devices that form at least a portion of a computing entity;

FIG. 3F is a diagram of an example of the functions of the operating system of a computing device;

FIG. 3G is a schematic block diagram of the hardware components of the hardware section of a computing device;

FIG. 4 is a schematic block diagram of an embodiment of a multi-access point item data extraction and management computing system;

FIG. 5 is a schematic block diagram of an embodiment of a portion of a multi-access point item data extraction and management computing system;

FIG. 6 is a schematic block diagram of an embodiment of a database;

FIG. 7 is a schematic block diagram of an embodiment of a data storage computing entity of a database;

FIG. 8 is a schematic block diagram of a data extraction module and a data processing module of an item data extraction and management computing entity;

FIGS. 9A-9B are schematic block diagrams of an embodiment of a computing device of the multi-access point item data extraction and management computing system;

FIG. 10 is a schematic block diagram of an embodiment of a computing device of the multi-access point item data extraction and management computing system interacting with an item data extraction and management computing entity;

FIG. 11 is a schematic block diagram of an embodiment of a computing device of the multi-access point item data extraction and management computing system;

FIG. 12 is a schematic block diagram of an embodiment of a computing device of the multi-access point item data extraction and management computing system;

FIG. 13 is a schematic block diagram of an embodiment of a computing device of the multi-access point item data extraction and management computing system interacting with an item data extraction and management computing entity;

FIG. 14 is a schematic block diagram of an embodiment of a computing device of the multi-access point item data extraction and management computing system interacting with an item data extraction and management computing entity;

FIG. 15 is a schematic block diagram of an embodiment of a computing device and a second computing device of the multi-access point item data extraction and management computing system;

FIG. 16 is a schematic block diagram of an embodiment of a second computing device of the multi-access point item data extraction and management computing system;

FIG. 17 is a schematic block diagram of an embodiment of a second computing device interacting with an item data extraction and management computing entity;

FIG. 18 is a schematic block diagram of an embodiment of a computing device and a second computing device;

FIG. 19 is a logic diagram of an example of a method of extracting and processing item data for storage; and

FIG. 20 is a logic diagram of another example of a method of extracting and processing item data for storage.

### DETAILED DESCRIPTION OF THE INVENTION

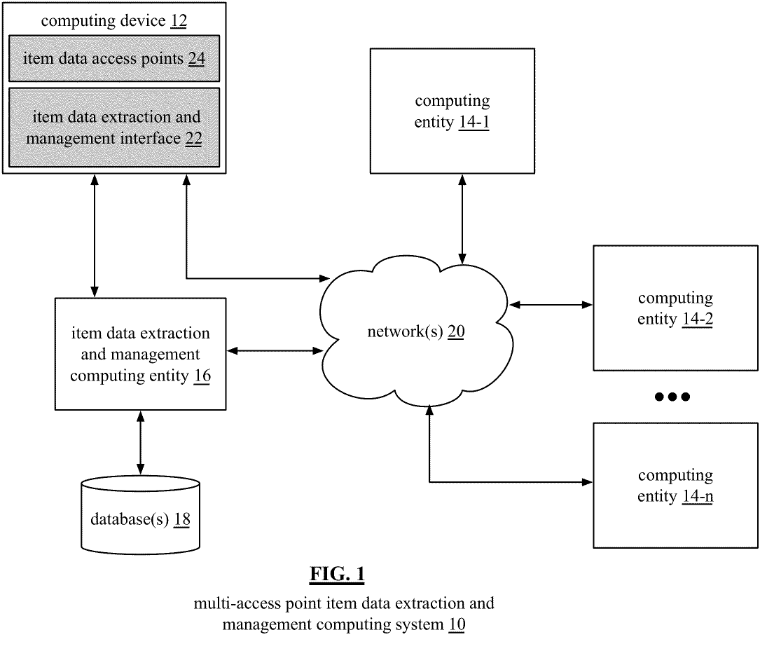

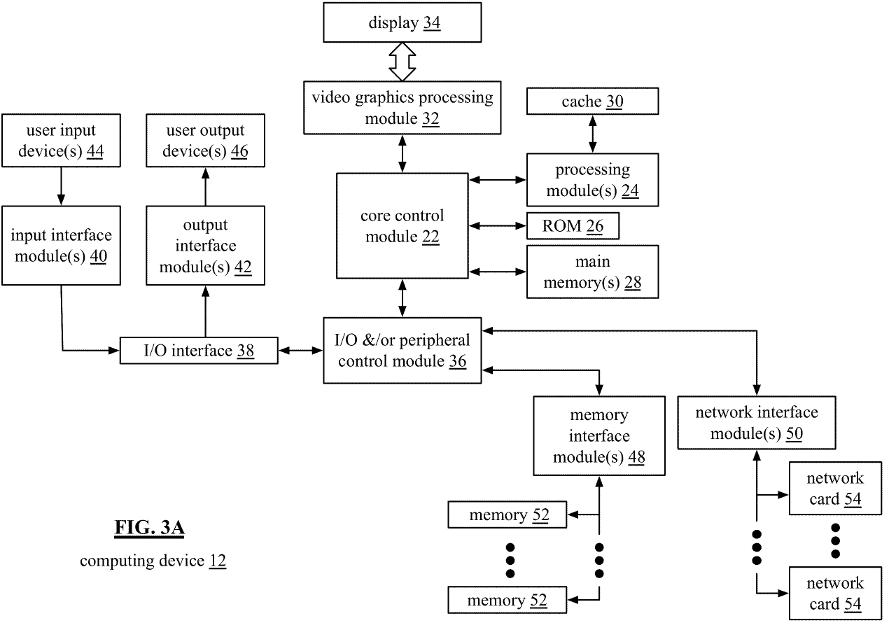

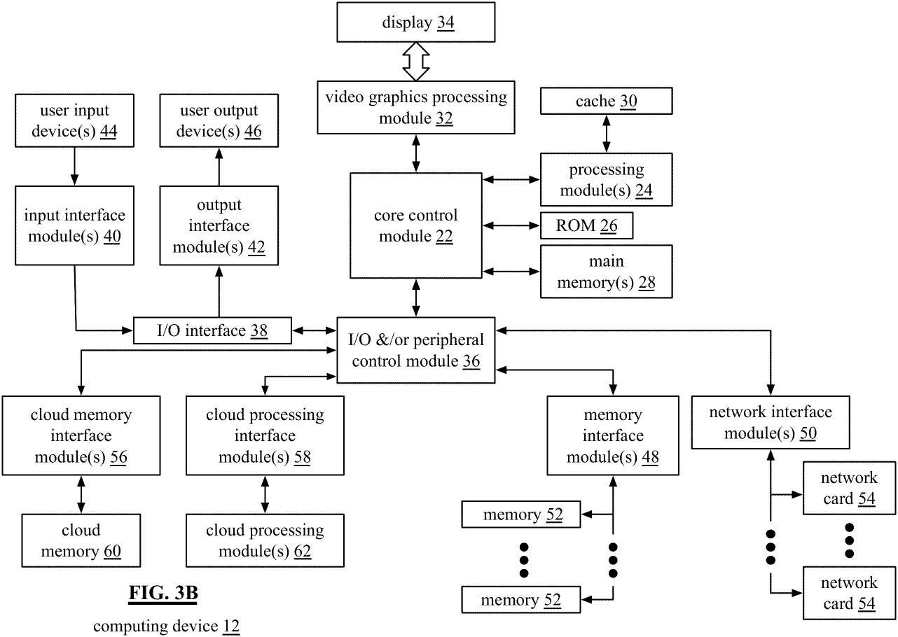

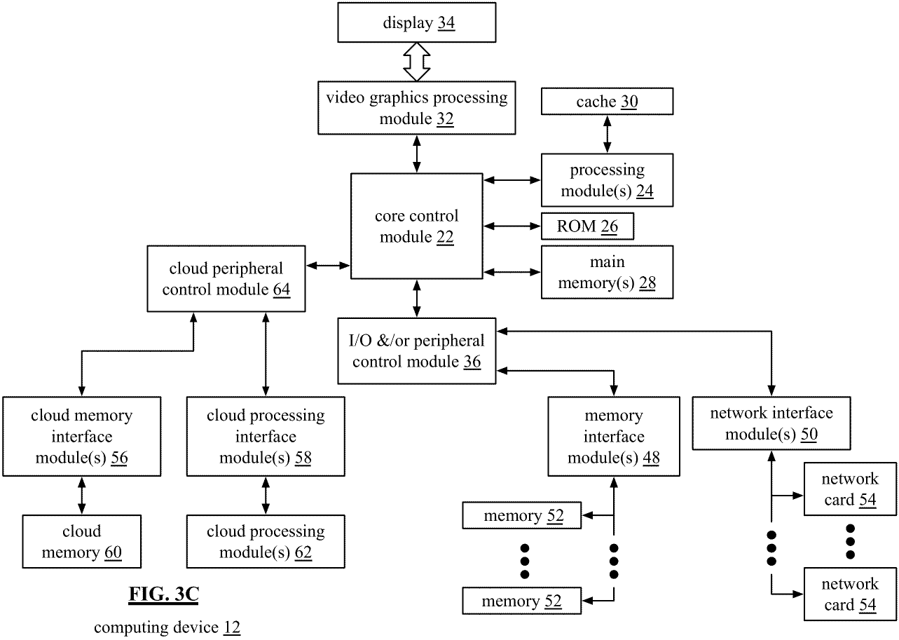

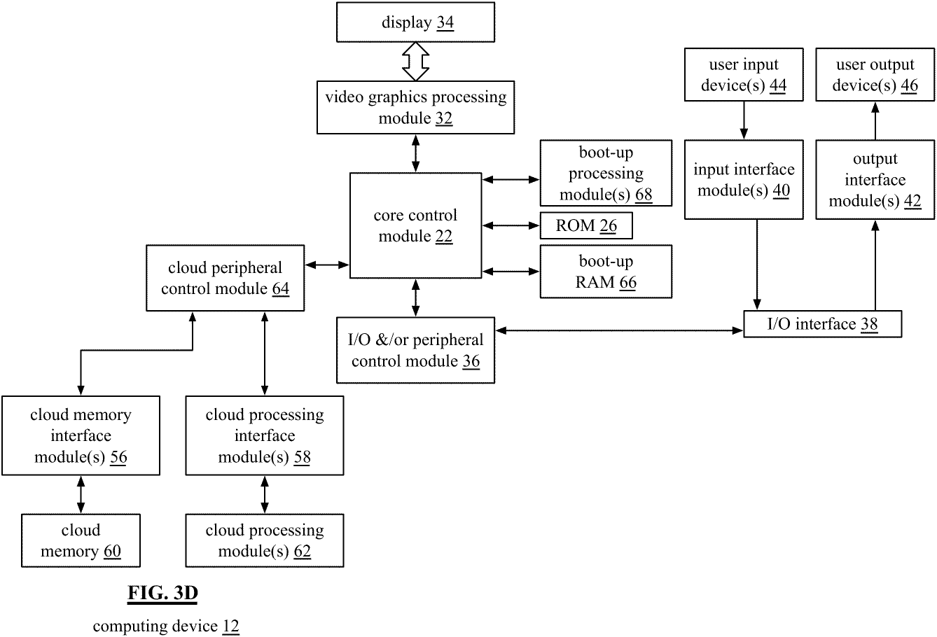

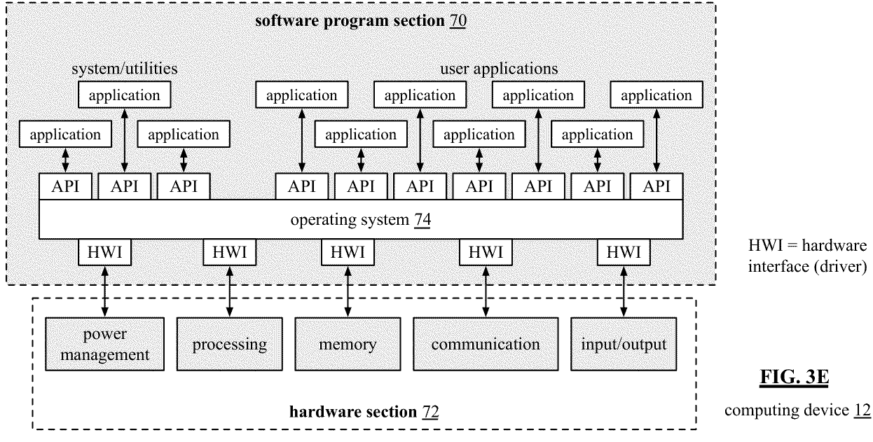

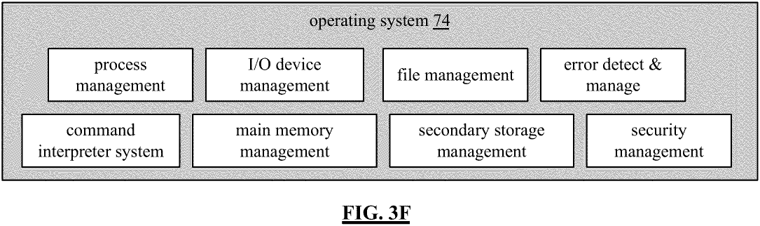

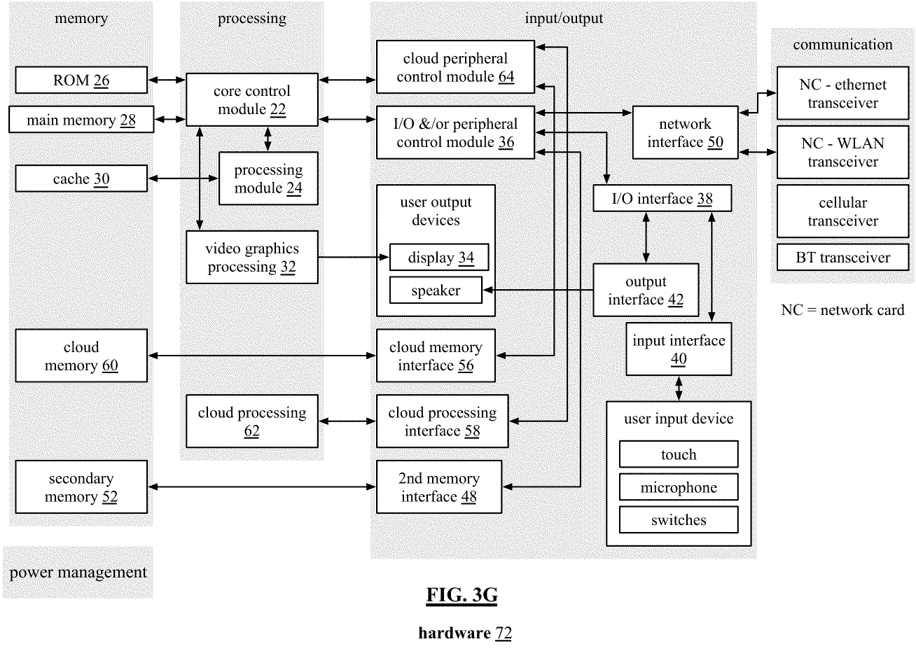

FIG. 1 is a schematic block diagram of an embodiment of a multi-access point item data extraction and management computing system 10 that includes a computing device 12, a plurality of computing entities 14-1 through 14-n, an item data extraction and management computing entity 16, database(s) 18, and network(s) 20. As used herein, a computing device may be one or more portable computing devices and/or one or more fixed computing devices. The computing device 12 (e.g., any of computing devices 12 of FIGS. 3A-3E) may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

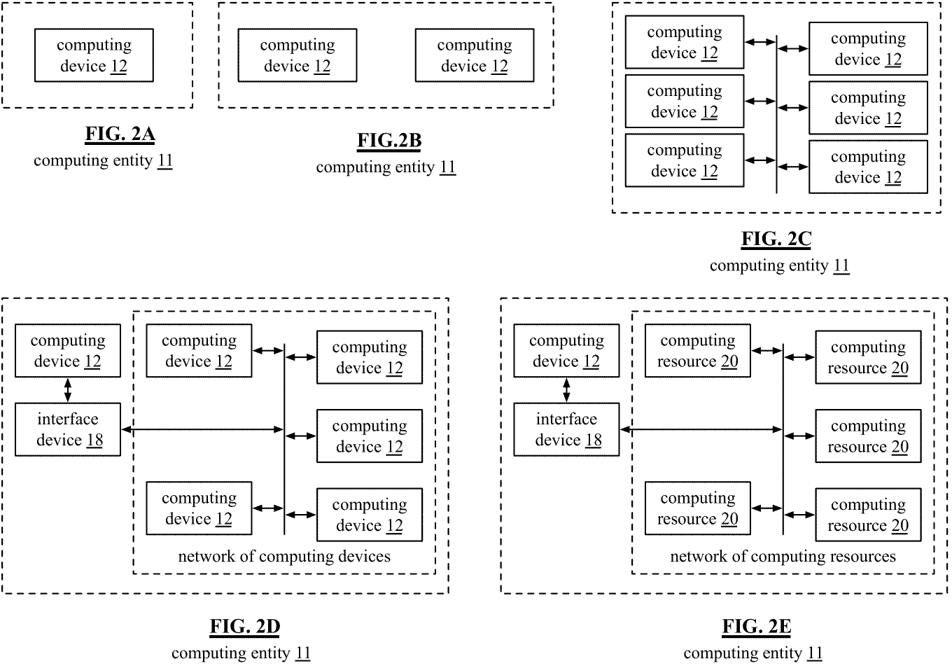

As discussed in more detail with reference to FIGS. 2A-2E, a computing entity may be one or more computing devices, one or more distributed computing devices, and/or one or more modules executing on one or more computing devices. Within the multi-access point item data extraction and management computing system 10, the plurality of computing entities 14-1 through 14-n and the item data extraction and management computing entity 16 may be one or more computing devices, one or more distributed computing devices, and/or one or more modules executing on one or more computing devices.

The network(s) 20 includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business’s wireless network and a WAN is the Internet, cellular telephone infrastructure, and/or satellite communication infrastructure.

The computing device 12 includes item data access points 24 and an item data extraction and management interface 22. The item data access points 24 include one or more of an image capture device (e.g., a camera), an image storage device (e.g., smart phone image storage), internet browser application(s) providing access to websites, communication application(s) (e.g., text messaging, email, etc.), and a file storage device (e.g., downloads folder, saved files, cloud storage, etc.). An item may be any type of consumer good a user may have a desire to catalog, organize, and/or visualize digitally. For example, an item may be clothing, artwork, furniture, collectables, etc. Item data includes any type of digital information related to an item. For example, item data may include text data, image data, audio, video, and/or metadata pertaining to item details (e.g., item size, item name, item type, item location (e.g., a store), item price, an item’s customer review, item rating, item specifications, item materials, etc.). As a specific example, item data may include HTML contents from a website that features an item. As another example, item data may include user input item data such as user inputted text data and/or images of an item.

The computing device 12 is associated with the item data extraction and management computing entity 16 via an item data extraction and management interface 22. For example, a user of the computing device 12 sets up a user account with the item data extraction and management computing entity 16 and downloads the item data extraction and management interface 22. The item data extraction and management interface 22 allows the computing device 12 to interface with features and functions of the item data extraction and management computing entity 16. The item data extraction and management interface 22 may be a mobile application when the computing device 12 is a smartphone, tablet or other mobile computing device. In another example, the item data extraction and management interface 22 may be a browser extension or plugin when the computing device 12 is a desktop computing device.

The database(s) 18 are special types of computing devices that are optimized for large scale data storage and retrieval. The database(s) 18 includes similar components to that of the computing device 12 and computing entities 14-1 through 14-n with more hard drive memory (e.g., solid state, hard drives, etc.) and potentially with more processing modules and/or main memory. Further, the database(s) 18 are typically accessed remotely; as such it does not generally include user input devices and/or user output devices. In addition, an embodiment of database(s) 18 is a standalone separate computing device and/or may be a cloud computing device.

The plurality of computing entities 14-1 through 14-n may be user computing devices similar to the computing device 12 that include item data extraction and management interfaces 22 for interaction with the item data extraction and management computing entity 16 or any other computing entity having item data. For example, the plurality of computing entities 14-1 through 14-n may be e-commerce websites and/or platforms, mobile applications, online storage medium that contains documents and/or portable document formats (pdfs), social media platforms, and/or any other computing entity having data resources accessible by the item data extraction and management computing entity 16.

The item data extraction and management computing entity 16 is operable to interface with the database(s) 18 for storage of user specific data, general data, and user shared data. The item data extraction and management computing entity 16 facilitates item data extraction from the item data access points 24 of the computing device 12, the database(s), and/or from the plurality of computing entities 14-1 through 14-n via the network(s) 20.

The item data extraction and management computing entity 16 may continually and automatically crawl and scrape data resources via the plurality of computing entities 14-1 through 14-n for information relevant to the multi-access point item data extraction and management computing system 10. Extracted data is parsed and analyzed by the item data extraction and management computing entity 16 and stored in the relevant portion of the database(s) 18.

Alternatively, or additionally, the item data extraction and management computing entity 16 may identify one or more active data access points of the computing device 12 and determine whether to extract, analyze, and/or store relevant data from the identified one or more active data access points. An active data access point may be an open web browser application, an open camera roll (or other storage device and/or application), an open item data extraction and management interface (e.g., a user has the mobile application open), an open mobile application associated with items, an open communication application (e.g., a text message application), etc.

Determining whether to extract, analyze, and/or store relevant data from an identified active data access point may be based on URL analysis (e.g., the URL is extracted and compared to a list of known URLs associated with items, the URL is extracted and analyzed for keywords associated with items, the URL is extracted and analyzed for keywords associated with actions such as a checkout page), user input (e.g., the user instructs the item data extraction and management computing entity 16 that data extraction is desired), default settings (e.g., whenever a particular data access point is active, always extract data, etc.), a type of mobile application (e.g., a mobile application is included in a list of mobile applications associated with items), and/or information obtained via connections (e.g., deep link) to other mobile applications on the computing device 12 (e.g., when a checkout page is opened within a mobile application).

FIGS. 2A-2E are schematic block diagrams of embodiments of computing entities that form at least part of a multi-access point item data extraction and management computing system. FIG. 2A is schematic block diagram of an embodiment of a computing entity 11 that includes a computing device 12 (e.g., one or more of the embodiments of FIGS. 3A- 3E). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 11 that includes two or more computing devices 12 (e.g., two or more from any combination of the embodiments of FIGS. 3A - 3E). The computing devices 12 perform the functions of a computing entity in a peer processing manner (e.g., coordinate together to perform the functions), in a master-slave manner (e.g., one computing device coordinates and the other support it), and/or in another manner.

FIG. 2C is schematic block diagram of an embodiment of a computing entity 11 that includes a network of computing devices 12 (e.g., two or more from any combination of the embodiments of FIGS. 3A - 3E). The computing devices are coupled together via one or more network connections (e.g., WAN, LAN, cellular data, WLAN, etc.) and preform the functions of the computing entity.

FIG. 2D is schematic block diagram of an embodiment of a computing entity 11 that includes a primary computing device (e.g., any one of the computing devices of FIGS. 3A - 3E), an interface device (e.g., a network connection) 18, and a network of computing devices 12 (e.g., one or more from any combination of the embodiments of FIGS. 3A - 3E). The primary computing device utilizes the other computing devices as co-processors to execute one or more the functions of the computing entity, as storage for data, for other data processing functions, and/or storage purposes.

FIG. 2E is schematic block diagram of an embodiment of a computing entity 11 that includes a primary computing device (e.g., any one of the computing devices of FIGS. 3A - 3E), an interface device (e.g., a network connection) 18, and a network of computing resources 20 (e.g., two or more resources from any combination of the embodiments of FIGS. 3A - 3E). The primary computing device utilizes the computing resources as co-processors to execute one or more the functions of the computing entity, as storage for data, for other data processing functions, and/or storage purposes.

FIGS. 3A-3E are schematic block diagrams of embodiments of computing devices that form at least a portion of a computing entity. FIG. 3A is a schematic block diagram of an embodiment of a computing device 12 that includes a plurality of computing resources. The computing resources include one or more core control modules 22, one or more processing modules 24, one or more main memories 28, a read only memory (ROM) 26 for a boot up sequence, cache memory 30, one or more video graphics processing modules 32, one or more displays 34 (optional), an Input-Output (I/O) peripheral control module 36, an I/O interface module 38 (which could be omitted if direct connect 10 is implemented), one or more input interface modules 40, one or more output interface modules 42, one or more network interface modules 50, and one or more memory interface modules 48.

A processing module 24 is described in greater detail at the end of the detailed description section and, in an alternative embodiment, has a direction connection to the main memory 28. In an alternate embodiment, the core control module 22 and the I/O and/or peripheral control module 36 are one module, such as a chipset, a quick path interconnect (QPI), and/or an ultra-path interconnect (UPI).

The processing module 24, the core control module 22, and/or the video graphics processing module 32 form a processing core for the computing device. Additional combinations of processing modules 24, core modules 22, and/or video graphics processing modules 32 form co-processors for the computing device. Computing resources of FIG. 2E include one more of the components shown in this Figure and/or in or more of FIGS. 3B-3E.

Each of the main memories 28 includes one or more Random Access Memory (RAM) integrated circuits, or chips. In general, the main memory 28 stores data and operational instructions most relevant for the processing module 24. For example, the core control module 22 coordinates the transfer of data and/or operational instructions between the main memory 28 and the secondary memory device(s) 52. The data and/or operational instructions retrieve from secondary memory 52 are the data and/or operational instructions requested by the processing module or will most likely be needed by the processing module. When the processing module is done with the data and/or operational instructions in main memory, the core control module 22 coordinates sending updated data to the secondary memory 52 for storage.

The secondary memory 52 includes one or more hard drives, one or more solid state memory chips, and/or one or more other large capacity storage devices that, in comparison to cache memory and main memory devices, is/are relatively inexpensive with respect to cost per amount of data stored. The secondary memory 52 is coupled to the core control module 22 via the I/O and/or peripheral control module 36 and via one or more memory interface modules 48. In an embodiment, the I/O and/or peripheral control module 36 includes one or more Peripheral Component Interface (PCI) buses to which peripheral components connect to the core control module 22. A memory interface module 48 includes a software driver and a hardware connector for coupling a memory device to the I/O and/or peripheral control module 36. For example, a memory interface 48 is in accordance with a Serial Advanced Technology Attachment (SATA) port.

The core control module 22 coordinates data communications between the processing module(s) 24 and network(s) via the I/O and/or peripheral control module 36, the network interface module(s) 50, and one or more network cards 54. A network card 54 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 50 includes a software driver and a hardware connector for coupling the network card to the I/O and/or peripheral control module 36. For example, the network interface module 50 is in accordance with one or more versions of IEEE 802.11, cellular telephone protocols, 10/100/1000 Gigabit LAN protocols, etc.

The core control module 22 coordinates data communications between the processing module(s) 24 and input device(s) 44 via the input interface module(s) 40, the I/O interface 38, and the I/O and/or peripheral control module 36. An input device 44 (e.g., user input device) includes a keypad, a keyboard, control switches, a touchpad, a microphone, a camera, etc. An input interface module 40 includes a software driver and a hardware connector for coupling an input device to the I/O and/or peripheral control module 36. In an embodiment, an input interface module 40 is in accordance with one or more Universal Serial Bus (USB) protocols.

The core control module 22 coordinates data communications between the processing module(s) 24 and output device(s) 46 via the output interface module(s) 42 and the I/O and/or peripheral control module 36. An output device 54 (e.g., user output device) includes a speaker, auxiliary memory, headphones, etc. An output interface module 42 includes a software driver and a hardware connector for coupling an output device to the I/O and/or peripheral control module 36. In an embodiment, an output interface module 42 is in accordance with one or more audio codec protocols.

The processing module 24 communicates directly with a video graphics processing module 32 to display data on the display 34. The display 34 includes an LED (light emitting diode) display, an LCD (liquid crystal display), and/or other type of display technology. The display has a resolution, an aspect ratio, and other features that affect the quality of the display. The video graphics processing module 32 receives data from the processing module 24, processes the data to produce rendered data in accordance with the characteristics of the display, and provides the rendered data to the display 34.

FIG. 3B is a schematic block diagram of an embodiment of a computing device 12 that includes a plurality of computing resources similar to the computing resources of FIG. 3A with the addition of one or more cloud memory interface modules 56, one or more cloud processing interface modules 58, cloud memory 60, and one or more cloud processing modules 62. The cloud memory 60 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 62 is similar to processing module 24 but is remoted from the core control module and is accessed via a network.

FIG. 3C is a schematic block diagram of an embodiment of a computing device 12 that includes a plurality of computing resources similar to the computing resources of FIG. 3B with a change in how the cloud memory interface module(s) 56 and the cloud processing interface module(s) 58 are coupled to the core control module 22. In this embodiment, the interface modules 56 and 58 are coupled to a cloud peripheral control module 64 that directly couples to the core control module 22.

FIG. 3D is a schematic block diagram of an embodiment of a computing device 12 that includes a plurality of computing resources, which includes include a core control module 22, a boot-up processing module 68, boot-up RAM 66, a read only memory (ROM) 26, a one or more video graphics processing modules 32, one or more displays 34 (optional), an Input-Output (I/O) peripheral control module 36, one or more input interface modules 40, one or more output interface modules 42, one or more cloud memory interface modules 56, one or more cloud processing interface modules 58, cloud memory 60, and cloud processing module(s) 62.

In this embodiment, the computing device 12 includes enough processing resources (e.g., module boot-up processing module 68, ROM 26, and RAM 26) to boot up. Once booted up, the cloud memory 60 and the cloud processing module(s) 62 function as the computing device’s memory (e.g., main and hard drive) and processing module.

FIG. 3E is a schematic block diagram of another embodiment of a computing device 12 that includes a hardware section 72 and a software program section 70. The hardware section 72 includes the hardware functions of power management, processing, memory, communications, and input/output. FIG. 3G illustrates the hardware section 72 in greater detail.

The software program section 70 includes an operating system 74, system and/or utilities applications, and user applications. The software program section further includes APIs and HWIs. APIs (application programming interface) are the interfaces between the system and/or utilities applications and the operating system and the interfaces between the user applications and the operating system 74. HWIs (hardware interface) are the interfaces between the hardware components and the operating system. For some hardware components, the HWI is a software driver. The functions of the operating system 74 are discussed in greater detail with reference to FIG. 3F.

FIG. 3F is a diagram of an example of the functions of the operating system 74 of a computing device 12. In general, the operating system functions to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 74 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include: load a process for execution; enable at least partial execution of a process; suspend execution of a process; resume execution of a process; terminate execution of a process; load operational instructions and/or data into main memory for a process; provide communication between two or more active processes; avoid deadlock of a process and/or interdependent processes; and control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of: file creation, editing, deletion, and/or archiving; directory creation, editing, deletion, and/or archiving; memory mapping files and/or directors to memory locations of secondary memory; and backing up of files and/or directories.

The Network Management OS function manages access to a network by the computing device. Network management includes: network fault analysis; network maintenance for quality of service; network access control among multiple clients; and network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 3G is a schematic block diagram of the hardware components of the hardware section 72 of a computing device. The memory portion of the hardware section includes the ROM 26, the main memory 28, the cache memory 30, the cloud memory 60, and the secondary memory 52. The processing portion of the hardware section includes the core control module 22, the processing module 24, the video graphics processing module 32, and the cloud processing module 62.

The input/output portion of the hardware section includes the cloud peripheral control module 64, the I/O and/or peripheral control module 36, the network interface module 50, the I/O interface module 38, the output device interface 42, the input device interface 40, the cloud memory interface module 56, the cloud processing interface module 58, and the secondary memory interface module 48. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

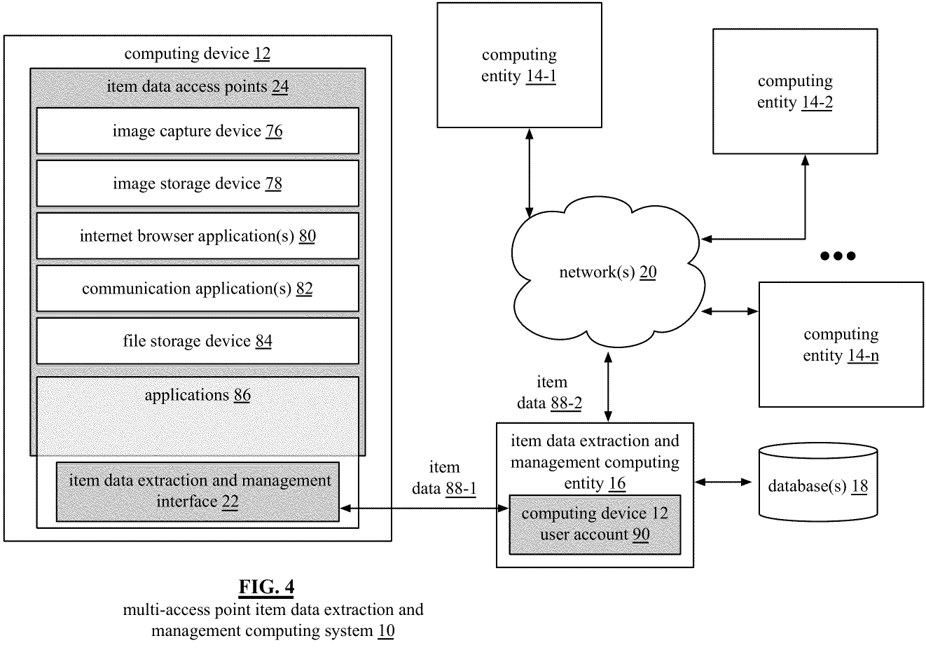

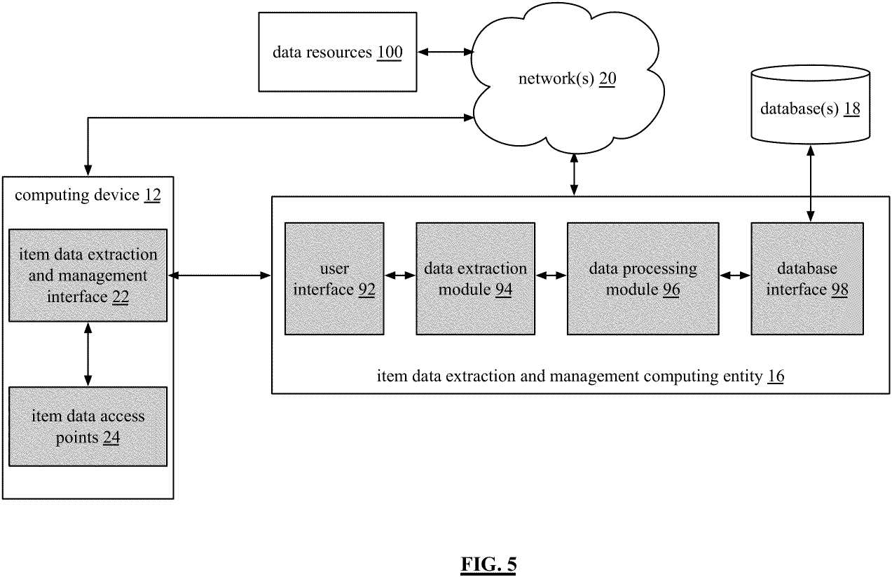

FIG. 4 is a schematic block diagram of an embodiment of a multi-access point item data extraction and management computing system 10 that includes a computing device 12, a plurality of computing entities 14-1 through 14-n, a user selected item database computing entity 16, database(s) 18, and network(s) 20. FIG. 4 operates similarly to the multi-access point item data extraction and management computing system 10 of FIG. 1 except that, in FIG. 4, the item data access points 24 of the computing device 12 are shown in more detail.

The item data access points 24 of the computing device 12 include an image capture device (e.g., a front and/or back camera of a smart phone) 76, an image storage device (e.g., a camera roll of a smart phone) 78, internet browser application(s) 80, communication application(s) 82 (e.g., text messaging, email, etc.), a file storage device 84 (e.g., downloads, saved files, cloud storage, etc.), and other applications 86 (e.g., e-commerce mobile applications). The computing device 12 further includes the item data extraction and management interface 22 which may be a mobile application installed on the computing device as shown. The computing device 12 is associated with the item data extraction and management computing entity 16 via the item data extraction and management interface 22 and a computing device 12 user account 90.

The item data extraction and management computing entity 16 is operable to extract item data 88-1 (e.g., item data, text data, item metadata, video data, etc.) from the item data access points 24 of the computing device 12 for use in the item data extraction and management computing system 10. The item data extraction and management computing entity 16 is also operable to extract item data 88-2 (e.g., item text data, item image data, etc.) from the plurality of computing entities 14-1 through 14-n (e.g., merchant online e-commerce platforms, other computing devices, etc.) via the network(s) 20.

In addition to item data, the item data extraction and management computing entity 16 is operable to obtain user data (e.g., user preferences, personal information, etc.) via the computing device 12 user account 90.

FIG. 5 is a schematic block diagram of an embodiment of a portion of a multi-access point item data extraction and management computing system 10 that includes a computing device 12, an item data extraction and management computing entity 16, database(s) 18, network(s) 20, and data resources 100. FIG. 5 operates similarly to the item data extraction and management computing system 10 of FIG. 1 except that, in FIG. 5, the item data extraction and management computing entity 16 is shown in more detail and data resources 100 are shown. The data resources 100 include one or more documents, web pages, pdfs, images, etc., accessible to the item data extraction and management computing entity 16 via the network(s) 20 (e.g., via the computing entities 14-1 through 14-n of previous Figures).

The item data extraction and management computing entity 16 includes a user interface 92, a data extraction module 94, a data processing module 96, and a database interface module 98. The item data extraction and management computing entity 16 may include more modules for other functions such as security, account management, content sharing, etc., and is not limited to what is shown. The user interface 92 interfaces with the item data extraction and management interface 22 and communicates data in a user accessible data format to the computing device 12 and obtains data (e.g., item data, user inputs, etc.) from the computing device 12. The data extraction module 94 collects item data from a source (e.g., the item data access points 24, data resources 100 (e.g., via computing entities 14-1 through 14-n via the network(s) 20), and the database(s) 18) in accordance with one or more algorithms and/or user inputs.

The data extraction module 94 may include web crawling, batch processing tools, web scraping, open source tools, and/or cloud based tools for data extraction. For example, the data extraction module 94 includes web and/or mobile application (e.g., mobile API scraping) scraping capabilities that allow for scraping of URLs of images and HTML information related to the image. The data extraction module 94 may extract data based on a request and/or automatically in accordance with a data extraction algorithm for identifying, categorizing, and organizing item data.

The data processing module 44 processes (e.g., parsing, data formatting, adding metadata/tags, data transformation and filtering, etc.) the extracted item data (e.g., images, text data associated with item data, etc.) to produce properly formatted and analyzed item data. For example, the data processing module includes a data parser operable to convert data to a desired format and a data indexer operable to categorize the data according to an indexing scheme (e.g., a data structure with columns for search conditions and a pointer) to prepare it for database storing and querying. The data processing module 96 may further include a data analyzer operable to categorize data (e.g., via smart tags) based on user preferences, system specifications, etc. In another embodiment, the data extraction module 94 and the data processing module 96 are the same or overlapping modules (e.g., the data extraction module includes a data parser).

The database interface module 98 provides the item data extraction and management computing entity 16 access to the system database(s) 18. The database interface module 98 may include data processing capabilities for formatting and sending data to the database(s) 18.

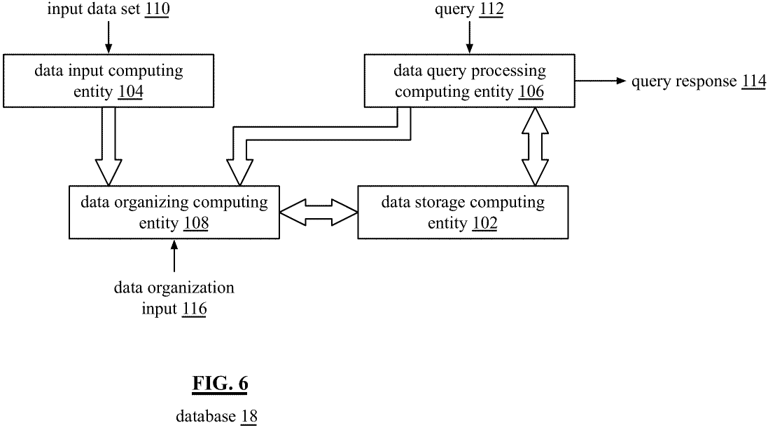

FIG. 6 is a schematic block diagram of an embodiment of a database 18 that includes a data input computing entity 104, a data organizing computing entity 108, a data query processing computing entity 106, and a data storage computing entity 102. Each of the computing entities is implemented in accordance with one or more of the embodiments of FIGS. 2A-2E.

The data input computing entity 104 is operable to receive an input data set 110 (e.g., via the database interface of the item data extraction and management computing entity). The input data set 110 is a collection of related data that can be represented in a tabular form of columns and rows, and/or other tabular structure. In an example, the columns represent different data elements of data for a particular source and the rows corresponds to the different sources (e.g., websites, devices, email communications, etc.).

If the data set 110 is in a desired tabular format, the data input computing entity 104 provides the data set to the data organizing computing entity 108. If not, the data input computing entity 110 reformats the data set to put it into the desired tabular format. In another example, the data processing module of the item data extraction and management computing entity formats the data set in the proper format for database storage and/or queries.

The data organizing computing entity 108 organizes the data set 110 in accordance with a data organizing input 116. In an example, the data organizing input 116 is regarding a particular query and requests that the data be organized for efficient analysis of the data for the query. In another example, the data organizing input 116 instructs the data organizing computing entity 108 to organize the data in a time-based manner. The organized data is provided to the data storage computing entity 102 for storage.

When the data query processing computing entity 106 receives a query 112, it accesses the data storage computing entity 102 regarding a data set for the query. If the data set is stored in a desired format for the query, the data query processing computing entity 106 retrieves the data set and executes the query to produce a query response 114. If the data set is not stored in the desired format, the data query processing computing entity 106 communicates with the data organizing computing entity 108, which re-organizes the data set into the desired format.

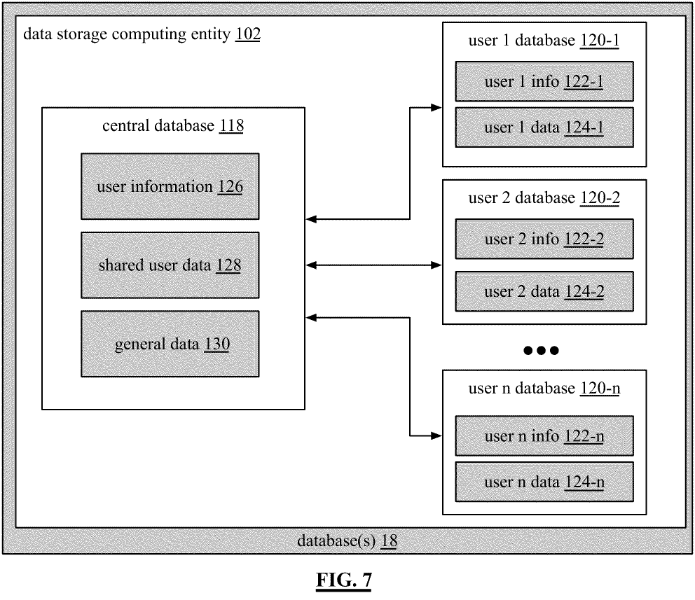

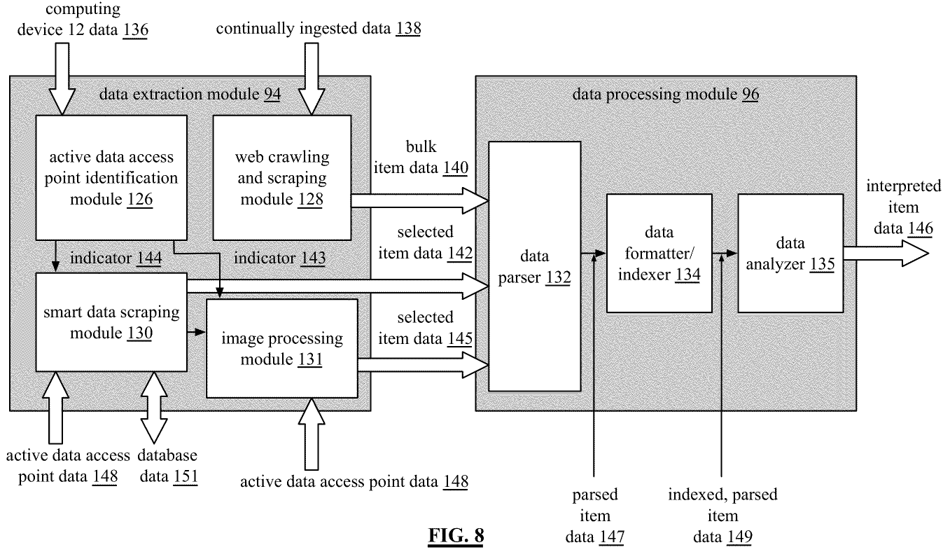

FIG. 7 is a schematic block diagram of an embodiment of a data storage computing entity 102 of a database 18 that includes a central database 118 and a plurality of user databases 120-1 through 120-n. The central database 118 stores general user information 112 (e.g., user preferences, personal information, account information, etc.), shared user data 128 (e.g., general item data that is sharable among system users), and general data 130 (e.g., system settings, item data identifiers, a URL library, keyword list, etc.). The user databases 120-1 through 120-n store user information 122 (e.g., user settings and preferences, etc.) and user data 124 (e.g., user specific item data).

FIG. 8 is a schematic block diagram of a data extraction module 94 and a data processing module 96 of an item data extraction and management computing entity. The data extraction module 94 includes an active data access point identification module 126, a web crawling and scraping module 128, a smart data scraping module 130, and an image processing module 131. The data processing module 96 includes a data parser 132, a data formatter/indexer 134, and a data analyzer 135.

The data extraction module 94 extracts data from multiple sources. The active data access point identification module 126 obtains computing device 12 data 136 regarding the data access points of the computing device. For example, the active data access point identification module 126 monitors actions and inputs of the computing device 12 (e.g., via data and/or event, passive and/or active monitoring tools installed via the item extraction and management interface) for triggering actions that signify an active data access point. A triggering action may be opening a mobile application, selecting a share image option, opening a web browser, opening a storage device interface (e.g., a smartphone camera roll), obtaining a user input, opening a particular page of a website, recognizing a particular URL based on a known library (or other lookup mechanism) of relevant URLs, recognizing a screenshot action, receiving a new email, etc. When a triggering action occurs, a data access point is considered active. When a data access point is considered active, the active data access point identification module 126 sends an indicator 144 and/or 143 to one or more of the smart data scraping module 130 and the image processing module 131.

The smart data scraping module 130 employs artificial intelligence and machine learning techniques to inspect a data access point for relevant information and then extracts the relevant data (rather than extracting all information and then analyzing the information which could slow down a website or pull private information). For example, website data is stored in predictable ways (e.g., data nested in tags). Using example data models and lists of keywords, data strings, and historical data (e.g., database data 151), the smart data scraping module 130 is “trained” to spot data related to items (e.g., an image URL, a price, a description, a purchased item in an email, etc.). By selectively scraping item data, the smart data scraping module 130 is operable to provide selected item data 142 based on active data access point data 148 to the data processing module 96.

When an active data access point is not a website, mobile application, or email inbox (e.g., screenshot action, image storage, etc.) the image processing module 130 may receive an indicator 143 to automatically extract images from locations based on user preferences (e.g., a data storage location labeled ″items″ is continually monitored for new item images) or may request a user input for further instruction (e.g., when a screenshot action is detected, the user may be sent a push notification asking whether to store the screenshot in the database). Further, if the smart data scraping module 130 is unable to scrape a website, the smart data scraping module 130 may send an indicator to the image processing module 130 to screenshot and/or record item data from the website. The image processing module 131 is operable to extract images via screenshot, screen record, and/or via a storage device and extract data from the images (e.g., via image processing machine learning techniques, OCR text recognition, etc.). The image processing module 131 is operable to provide selected item data 145 based on active data access point data 148 to the data processing module 96.

The web crawling and scraping module 128 operates in accordance with known web crawling and scraping techniques in order to discover and collect item data from a plurality of data resources that will likely be desired by users. The web crawling and scraping module 128 uses artificial intelligence and automation to repeatedly search for specific types of item data (e.g., new products, reviews, prices, sizes, colors, materials, images, etc.). The continually ingested data 138 is processed by the data processing module 96 and stored by the databases. When a known URL is an active data access point, instead of scraping data from the website, the data extraction module may first query the database (e.g., database data 151) for stored information regarding the URL (e.g., when this data was already collected by the web crawling and scraping module and processed by the data processing module for storage). The web crawling and scraping module 128 provides bulk item data 140 to the data processing module 96.

The data parser 132 of the data processing module 96 obtains the bulk item data 140 and the selected item data 142 and 145 from the data extraction module 94. The data parser 132 converts the bulk item data 140 and/or the selected item data 142 and 145 into a desired data format (e.g., parsed item data 147) for use within the system (e.g., HTML to object definition language or database language). The data formatter/data indexer 134 takes the parsed item data 147 and further processes it to produce indexed, parsed item data 149 for storage in the database. Data indexing powers database queries by providing a method to quickly lookup the requested data (e.g., a pointer to data in a table). The data analyzer 135 analyzes the indexed, parsed item data 149 data to add metadata and/or assign smart tags (e.g., based on machine learning and natural language processing) to associate item data with specific categories, locations, etc. in accordance with user preferences, system specifications, etc. Analyzing the indexed, parsed item data 149 to assign smart tags and metadata produces interpreted item data 146. One or more of the data processing module 96 functions may be incorporated in one or more of the modules of the data extraction module 94.

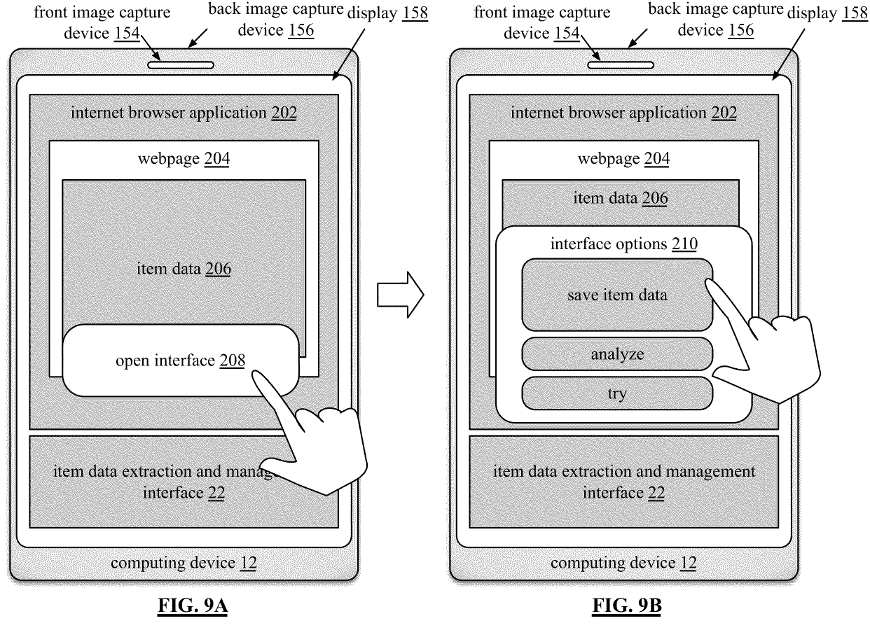

FIGS. 9A-9B are schematic block diagrams of an embodiment of a computing device 12 of the multi-access point item data extraction and management computing system. FIG. 9A depicts a user interface perspective of the computing device 12. In this example, the computing device 12 is a smart phone or similar computing device (e.g., tablet) that includes a front image capture device 154 (e.g., a camera), a back image capture device 156 (e.g., a camera), and a touchscreen display 156.

The computing device 12 includes the item data extraction and management interface 22 that interfaces with the item data extraction and management computing entity of previous Figures and an internet browser application 202. In this example, a user has the internet browser application 202 open to a webpage 204. The open webpage 204 and/or internet browser application 202 may be identified as an active data access point by the item data extraction and management interface 22 when the webpage 204 and/or internet browser application 202 is opened (e.g., the item data extraction and management interface 22 monitors actions of the computing device 12). When the open webpage 204 and/or internet browser application 202 is identified as an active data access point by the item data extraction and management interface 22, the item data extraction and management interface 22 determines whether to extract item data. In an embodiment, the item data extraction and management interface 22 waits for a user input to determine whether to extract data. In another embodiment, the item data extraction and management interface 22 sends a notification to the user regarding whether to extract item data. In another embodiment, the item data extraction and management interface 22 inspects the webpage 204 to determine whether to extract item data.

In this example, item data 206 on the webpage 206 is associated with a share feature (e.g., an embedded feature of mobile internet browser applications). The user may select the share feature to display share options (e.g., text, email, print, open an application, etc.). Here, the user selects the share feature and chooses to open the item data extraction and management interface 22 (open interface 208). Selecting the share feature may be the user input the item data extraction and management interface 22 is waiting for to determine whether to extract data from the active data access point or selecting the share feature is the triggering action that makes the webpage 204 the active data access point. In an alternative example, instead of accessing the item data via the internet browser application 202, the user accesses a webpage or shopping site via a merchant mobile application stored on the computing device 12.

FIG. 9B continues the example of FIG. 9A where a user selects a share feature associated with item data 206 (e.g., an image). When the open interface option is selected, interface options 210 are presented. In another embodiment, the open interface option is a ″save to interface″ option, where selecting the ″save to interface option″ saves the relevant item data to the user selected item database system interface 22.

As another option, the interface options 210 may include the option to analyze the item 206 to determine whether the item is a good fit for the user’s items, whether it goes with any item combinations, whether it fits within the user’s budget, etc. As another option, the interface options 210 may include the option to try the item via a saved avatar or via a virtual reality application. In this example, the user selects to save the item data to the user selected item database system.

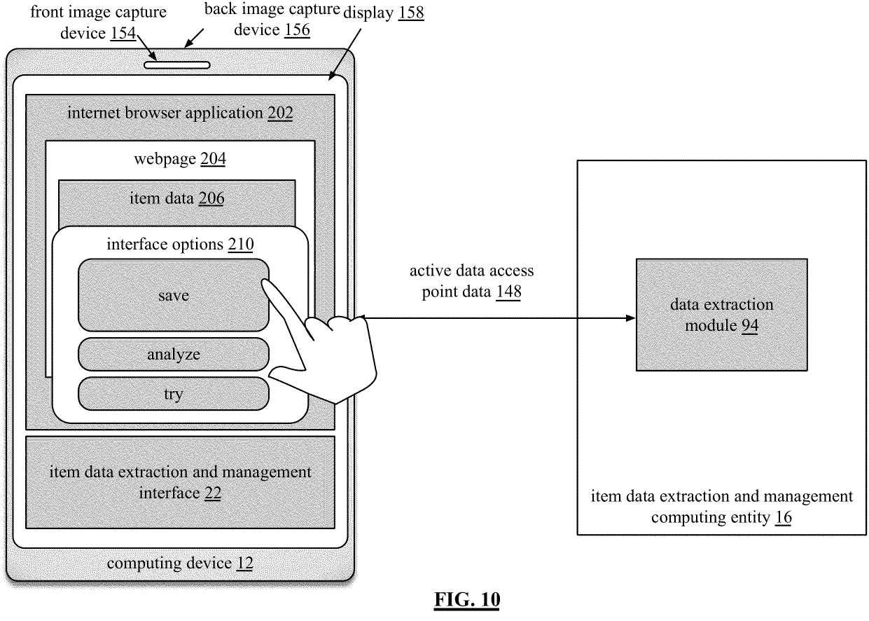

FIG. 10 is a schematic block diagram of an embodiment of a computing device 12 of the multi-access point item data extraction and management computing system interacting with an item data extraction and management computing entity 16. FIG. 10 continues the example of FIGS. 9A-9B where a user selects a share feature associated with an item. When the open interface option is selected, interface options 210 are presented and the user selects to save the item to the database. When an save item option is selected, the data extraction module 94 is operable to inspect the webpage for relevant data (e.g., based on the item associated with the share feature, using a stored data model associated with the data access point, based on keywords, based on known data tags, based on a library of known URLs, etc.), scrape the relevant item data (e.g., item image data (e.g., a URL), item text data (e.g., HTML), item metadata data, etc.) from the webpage 204, process the relevant item data, and save the item data to the database.

To collect item data from a mobile application, the data extraction module may implement a man in the middle proxy to intercept HTTPS communication between a mobile application and its backend API. The extracted data can then be processed by the item data extraction and management computing entity 16 for a particular purpose (e.g., storage, analysis, try, etc.).

FIG. 11 is a schematic block diagram of an embodiment of a computing device 12 of the multi-access point item data extraction and management computing system. FIG. 11 depicts a user interface perspective of the computing device 12. The computing device 12 includes the item data extraction and management interface 22 that interfaces with the item data extraction and management computing entity of previous Figures and an internet browser application 202. In this example, a user has the internet browser application 202 open to a webpage 204. In this example, the user takes a screenshot 212 of an item image displayed on the webpage 204. The item data extraction and management interface 22 identifies the screenshot as an active data access point.

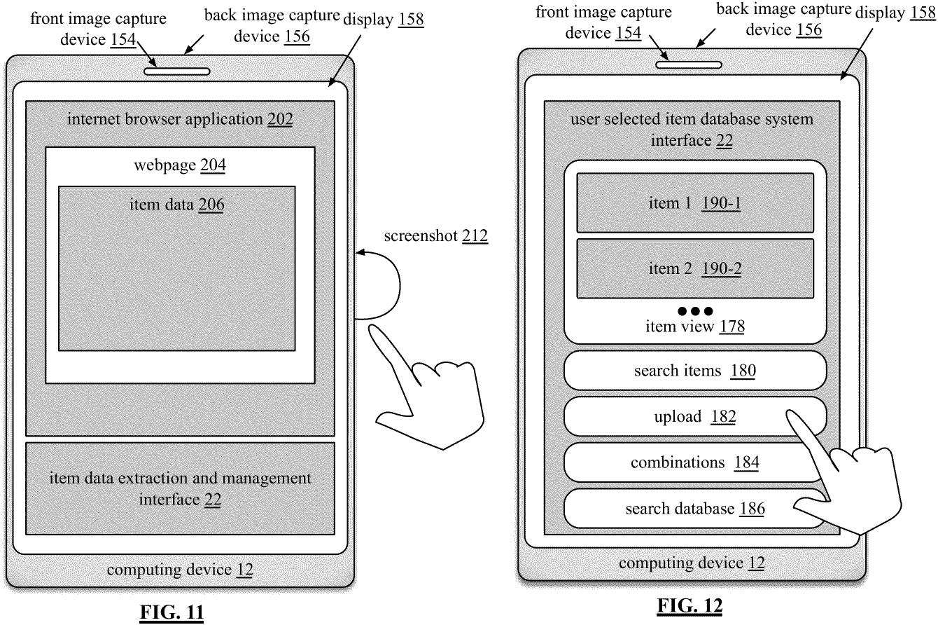

FIG. 12 is a schematic block diagram of an embodiment of a computing device 12 of the multi-access point item data extraction and management computing system. FIG. 12 continues the example of FIG. 11 where a user takes a screenshot 212 of an image of the item displayed on the webpage 204. The screenshot is saved to the computing device 12′s image storage. With the active data access point of a screenshot, the item data extraction and management interface 22, may automatically open and display options to the user. For example, the user can select to upload 182 the screenshot (or any image saved in the image storage) to add it to the database of the multi-access point item data extraction and management computing system. In another example, taking a screenshot triggers an automatic upload to the database. The upload may involve further image processing (e.g., optical character recognition (OCR)) and analysis. In another example, the user may be prompted to add additional information to the item data (e.g., price, care details, etc.).

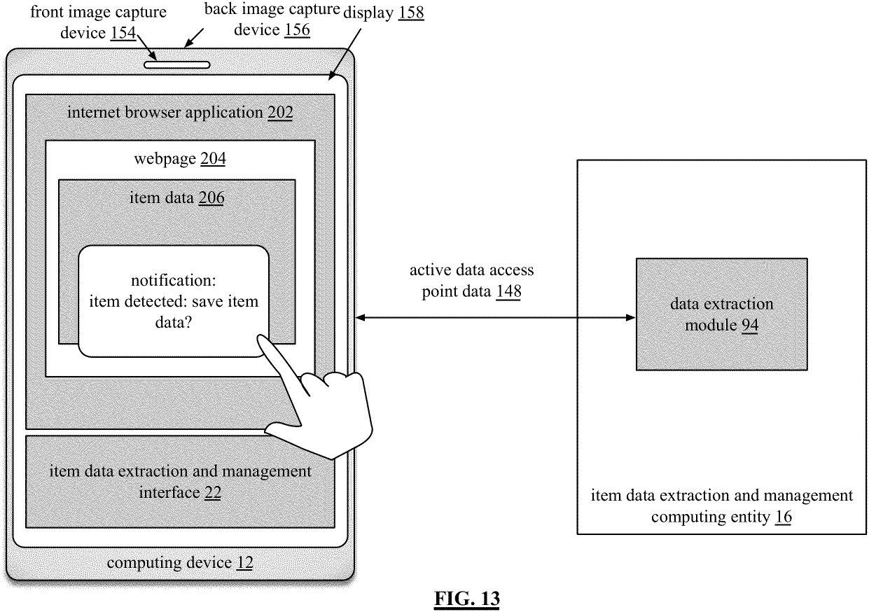

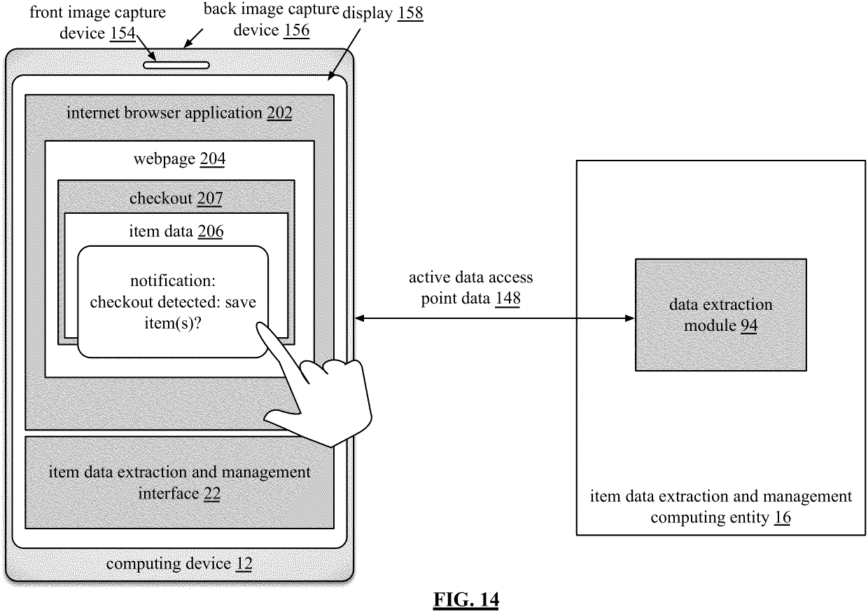

FIG. 13 is a schematic block diagram of an embodiment of a computing device 12 of the multi-access point item data extraction and management computing system interacting with an item data extraction and management computing entity 16. In this example, the item data extraction and management computing entity 16 has detected an active data access point (e.g., a webpage 204). When the active data access point is detected, a push notification may be sent to the user notifying the user that possible item data is detected and asking whether the user would like to save and/or analyze the item data. In another embodiment, the data extraction module 94 automatically inspects and smart scrapes active data access point data 148 from the webpage 204.

FIG. 14 is a schematic block diagram of an embodiment of a computing device 12 of the multi-access point item data extraction and management computing system interacting with an item data extraction and management computing entity 16. In this example, the item data extraction and management computing entity 16 has detected an active data access point (e.g., a checkout page 207 of a webpage 204 containing item data 106). When the active data access point is detected, a push notification may be sent to the user notifying the user that possible item data is detected and asking whether the user would like to save and/or analyze item data. In another embodiment, the data extraction module 94 automatically inspects and scrapes active data access point data 148 from the checkout page 207. Due to the smart scraping capabilities of the data extraction module, private information such as user payment details may be avoided and desired information such as image data may be extracted.

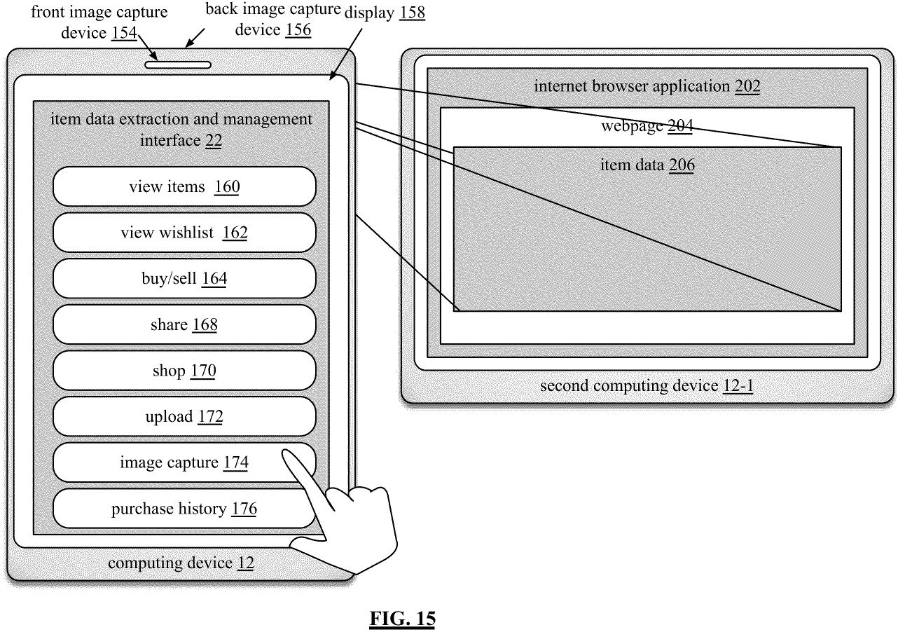

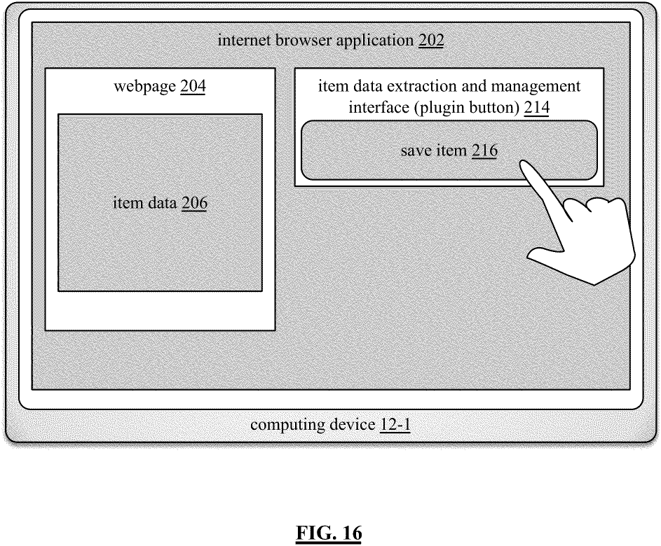

FIG. 15 is a schematic block diagram of an embodiment of a computing device 12 and a second computing device 12-1 of the multi-access point item data extraction and management computing system. The second computing device 12-1 is associated with a user of the computing device 12. For example, the second computing device 12-1 is a user’s desktop computer or laptop and the computing device 12 is the user’s smart phone. FIG. 15 depicts a user interface perspective of the computing device 12. The computing device 12 includes the item data extraction and management interface 22 that interfaces with the item data extraction and management computing entity of previous Figures. From a user interface perspective, the item data extraction and management interface 22 includes several options such as view items 160, view wish list 162, buy/sell 164, share 168, shop 170, upload 172, image capture 174, and purchase history 176.

The second computing device 12-1 includes an internet browser application 202 that is open to a webpage 204 containing item data 206. In this example, the user selects an option to capture an image 174 which triggers the back image capture device 156 to open and allow the user to capture the item data 206 from the display of the second computing device 12-1. With the capture an image option selected, the image storage device of the computing device 12 is identified as the active data access point. When the user captures an image, the user may be prompted to add additional information to the item data (e.g., price, care details, etc.). In another example, the data processing module includes image processing capabilities to extract text data from an image to determine item details.

In another embodiment, the item data extraction and management computing entity identifies a new photo or screenshot action of the computing device 12 as an active data access point and sends a push notification regarding whether to save the new photo screenshot to the database or automatically saves and/or analyzes the image.

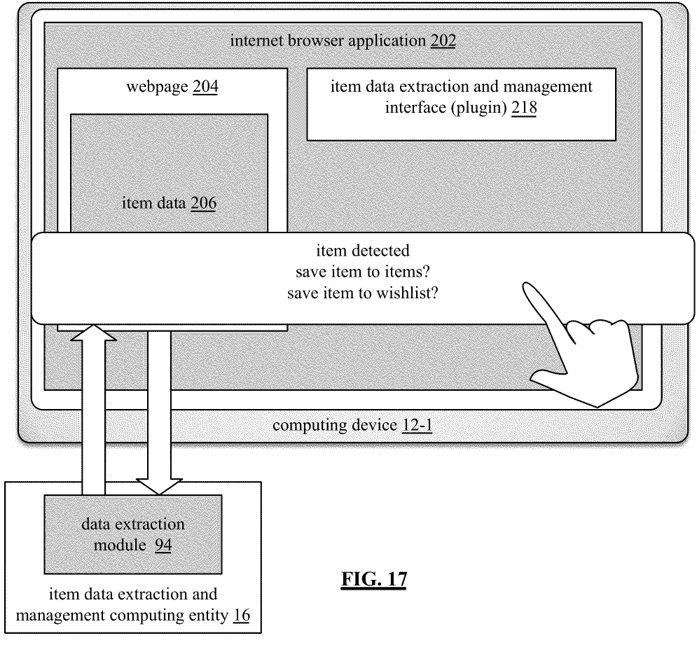

FIG. 16 is a schematic block diagram of an embodiment of a second computing device 12-1 of the multi-access point item data extraction and management computing system. The second computing device 12-1 is associated with a user of the computing device 12. For example, the second computing device 12-1 is a user’s desktop computer or laptop and the computing device 12 is the user’s smart phone. The second computing device 12-1 includes an internet browser application 202 that is open to a webpage 204 containing item data 206. In this example the internet browser application 202 has been installed with an item data extraction and management interface plugin button 214 (e.g., a desktop version of the item data extraction and management interface).

By selecting the item data extraction and management interface plugin button 214, the item data extraction and management computing entity is made aware of an active data access point. Once selected, a notification asks the user whether the user would wish to save and/or analyze the relevant item data 206 found on a current webpage 204. Alternatively, when the button 214 is selected, the item data extraction and management computing entity inspects the webpage 204 to determine whether relevant item data is present, and if so, automatically scrapes, processes, and stores the item data 206.

FIG. 17 is a schematic block diagram of an embodiment of a second computing device 12-1 interacting with an item data extraction and management computing entity 16. The second computing device 12-1 is associated with a user of the computing device 12. The second computing device 12-1 includes an internet browser application 202 that is open to a webpage 204 containing item data 206. In this example, the internet browser application 202 has been installed with an item data extraction and management interface (plugin/browser extension) 218 associated with the data extraction module that allows the data extraction module 94 of the item data extraction and management computing entity 16 to detect active data access points and extract data from the computing device 12-1 via the internet browser application 202.

When the active data access point (the open webpage 204 containing item data 206) is detected, a notification asks the user whether the user would like to save and/or analyze the item data 206. Alternatively, the item data extraction and management computing entity 16 inspects the webpage for relevant item data and if relevant item data is identified, the item data extraction and management computing entity 16 automatically scrapes, processes, and stores the relevant item data 206.

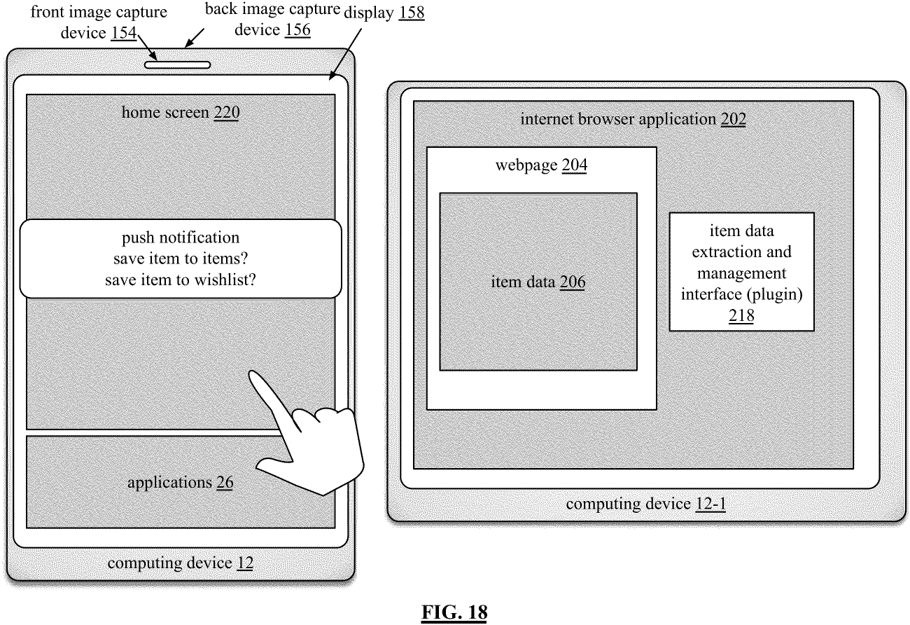

FIG. 18 is a schematic block diagram of an embodiment of a computing device 12 and a second computing device 12-1. The second computing device 12-1 is associated with a user of the computing device 12. The second computing device 12-1 includes an internet browser application 202 that is open to a webpage 204 containing item data 206. The internet browser application 202 has been installed with an item data extraction and management interface (e.g., a plugin/browser extension) 218 that allows the item data extraction and management computing entity 16 to identify item data on the internet browser application 202.

When the active data access point (the open webpage 204 containing item data 206) is detected on the second computing device 12-1, a push notification is sent to the computing device 12 to ask the user whether the user would wish to save and/or analyze the item data 206.

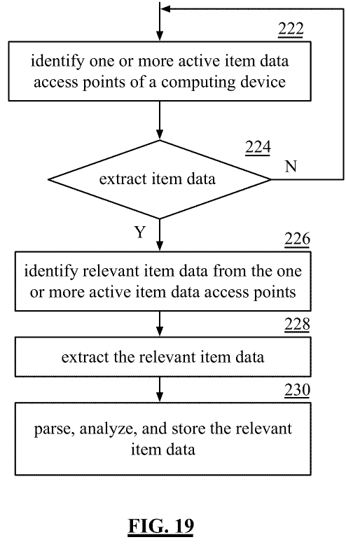

FIG. 19 is a logic diagram of an example of a method of extracting and processing item data for storage. The method begins with step 222 where the item data extraction and management computing entity of the multi-access point item data extraction and management computing system identifies one or more active item data access points of a computing device. Installing the item data extraction and management interface allows the item data extraction and management computing entity to access computing device data, to access other applications on the computing device, send notifications, receive user inputs, etc. Data access points include an image storage device, file storage device, internet browser applications, communication applications, images, text messages, emails, etc. The item data extraction and management computing entity monitors actions of the computing device via the item data extraction and management interface installed on the computing device to determine whether an item data access point is active.

Actions that signify an active item data access point may include opening an internet browser application, accessing a particular website, accessing a particular webpage on a website, opening a storage application and/or device (e.g., document and/or image storage), opening a communication application (e.g., text message), receiving a new email, a user input (e.g., opening the item data extraction and management interface and entering user inputs and/or answering prompts), using a camera of the computing device, taking a screenshot, selecting a share feature associated with an image (e.g., in a text message, on a website, in image storage, etc.), scanning a barcode, etc.

The method continues with step 224 where the item data extraction and management computing entity determines whether to extract data from an active data access point. For example, the item data extraction and management computing entity may send a push notification to the user of the computing device to determine whether to extract item data. In another example, user settings and/or preferences may determine whether to perform data extraction (e.g., whenever a new email is received regarding a new purchase, extract data, etc.). In another example, the item data extraction and management computing entity may perform a cursory analysis of the active data access point to determine whether item data is present. For example, the item data extraction and management computing entity analyzes the URL of a website that the computing device is accessing and compares the URL to a known list of URLs. If the URL is in the known list, the item data extraction and management computing entity determines to extract data from the website.

When the item data extraction and management computing entity determines not to extract item data at step 224 (e.g., a user input declines extraction, the active data access point does not include item data, etc.), the method branches back to step 222 where the item data extraction and management computing entity identifies one or more active item data access points. When the item data extraction and management computing entity determines to extract item data at step 224, the method continues with step 226 where the item data extraction and management computing entity identifies relevant item data from the one or more active data access points. For example, when the active item data access point is a website, the item data extraction and management computing entity may inspect the HTML of the page for keywords (e.g., based on tags related to items). In another example, the item data extraction and management computing entity may be able to identify relevant item data based on a URL alone. For example, when a URL identifies a webpage with a known data structure (e.g., a Shopify webpage, Amazon, etc.), item data is known to be present and the location is also known or can be closely estimated (e.g., based on stored data models) for extraction.

In another example, the item data extraction and management computing entity may not be able to identify relevant item data (e.g., a website prevents inspection). In that case, the item data extraction and management computing entity may ask the user if they would like to add item data (e.g., a photo, item details) manually via user input. In another example where the active data access point is a screenshot action or camera use, the item data extraction and management computing entity may implement image processing based on machine learning to identify items or item data from an image. In another example where the item data extraction and management computing entity may not be able to identify relevant item data (e.g., scraping is not allowed by a website), the item data extraction and management computing entity may record the screen and/or take a screenshot of the page and implement image processing based on machine learning to identify items or item data from the image and/or recording.

The method continues with step 228 where the item data extraction and management computing entity extracts the relevant item data. For example, based on the keywords found on a website, the item data extraction and management computing entity extract data associated with those keywords. With smart scraping (e.g., extracting data based on identified key words) private and/or sensitive data can remain protected. For example, item data from a checkout page can be extracted whereas payment information is not inspected or extracted unless specifically desired and instructed by a user (e.g., the user may wish to automatically store payment details in a user profile). In another example, the item data extraction and management computing entity is operable to save an image as item data (e.g., from a screenshot function) and analyze an image (e.g., via a screenshot) to determine and extract text item data.

The method continues with step 230 where the item data extraction and management computing entity parses, analyzes, and stores, via the database, the relevant item data. For example, the data processing module includes a data parser operable to convert data to a desired format (e.g., parsed item data) and a data indexer operable to categorize the data according to an indexing scheme (e.g., a data structure with columns for search conditions and a pointer) to prepare it for database storing and querying.

The data parser of the data processing module obtains bulk item data (e.g., from continual web crawling and scraping) and the selected item data (e.g., relevant data extracted from one or more active data access points). The data parser converts the bulk item data and/or the selected item data into a desired data format for use within the system (e.g., HTML to object definition language or database language). A data formatter/data indexer takes the parsed and/or tagged data and further processes it to produce processed data for storage in the database. Data indexing powers database queries by providing a method to quickly lookup the requested data (e.g., a pointer to data in a table).

The data processing module is operable to analyze the parsed and/or indexed item data and add metadata and/or assign smart tags (e.g., based on machine learning and natural language processing) to associate item data with specific categories, locations, etc. (e.g., interpreted item data). The item data extraction and management computing entity stores one or more of the relevant, parsed, and/or interpreted item data in one or more databases. Based on the type of item data, user preferences, user settings, default settings, etc., the item data extraction and management computing entity may store the one or more of the relevant, parsed, and/or interpreted item data in a private user database, a shared user database, and/or a general system database.

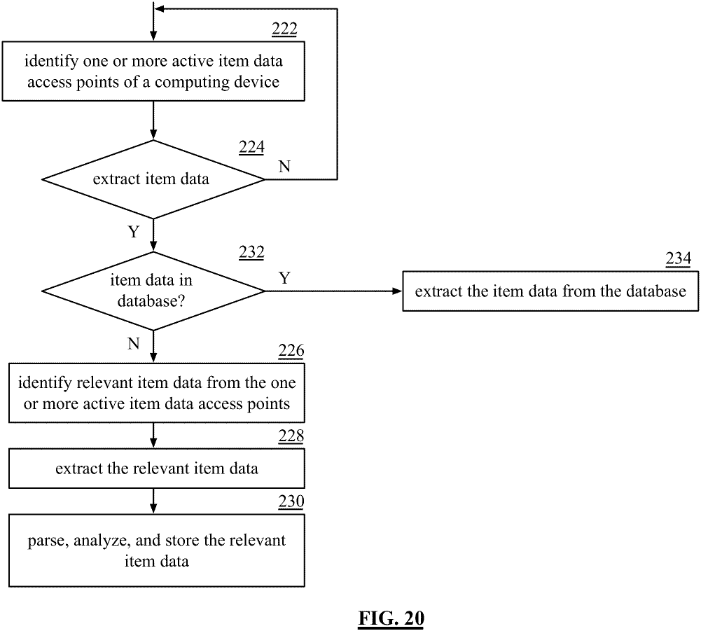

FIG. 20 is a logic diagram of another example of a method of extracting and processing item data for storage. The method begins with step 222 of FIG. 19 where the item data extraction and management computing entity of the multi-access point item data extraction and management computing system identifies one or more active item data access points of a computing device.

The method continues with step 224 of FIG. 19 where the item data extraction and management computing entity determines whether to extract data from an active data access point. For example, the item data extraction and management computing entity may send a push notification to the user of the computing device to determine whether to extract item data. In another example, user settings and/or preferences may determine whether to perform data extraction (e.g., whenever a new email is received regarding a new purchase, extract data, etc.). In another example, the item data extraction and management computing entity may perform a cursory analysis of the active data access point to determine whether item data is present. For example, the item data extraction and management computing entity analyzes the URL of a website that the computing device is accessing and compares the URL to a known list of URLs. If the URL is in the known list, the item data extraction and management computing entity determines to extract data from the website.

When the item data extraction and management computing entity determines not to extract item data at step 224 (e.g., a user input declines extraction, the active data access point does not include item data, etc.), the method branches back to step 222 where the item data extraction and management computing entity identifies one or more active item data access points. When the item data extraction and management computing entity determines to extract item data at step 224, the method continues with step 232 where the item data extraction and management computing entity sends a query to the database regarding the item data is likely in the database. For example, when the item data extraction and management computing entity performs a cursory analysis of the active data access point and determine that item data is present, the item data extraction and management computing entity uses the item data present as the database query.

When the item data is in the database, the method continues with step 234 where the item data extraction and management computing entity accesses the item data from the database. For example, the item data extraction and management computing entity pulls and/or duplicates the item data from a shared database and stores it in a private user database. When the item data is not in the database or the item data is outdated (e.g., based on a timestamp comparison), the method continues with step 226-230 of FIG. 19.

As may be used herein, the terms ″substantially″ and ″approximately″ provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/- 1%). Some relativity between items may range from a difference of less than a percentage level to a few percent. Other relativity between items may range from a difference of a few percent to magnitude of differences.

As may also be used herein, the term(s) ″configured to″, ″operably coupled to″, ″coupled to″, and/or ″coupling″ includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as ″coupled to″.

As may even further be used herein, the term ″configured to″, ″operable to″, ″coupled to″, or ″operably coupled to″ indicates that an item includes one or more of power connections, input(s), output(s), etc., to perform, when activated, one or more its corresponding functions and may further include inferred coupling to one or more other items. As may still further be used herein, the term ″associated with″, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term ″compares unfavorably″, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X > 5 is equivalent to determining if -X < -5, and the comparison to determine if signal A matches signal B can likewise be performed by determining -A matches -B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase ″at least one of a, b, and c″ or of this generic form ″at least one of a, b, or c″, with more or less elements than ″a″, ″b″, and ″c″. In either phrasing, the phrases are to be interpreted identically. In particular, ″at least one of a, b, and c″ is equivalent to ″at least one of a, b, or c″ and shall mean a, b, and/or c. As an example, it means: ″a″ only, ″b″ only, ″c″ only, ″a″ and ″b″, ″a″ and ″c″, ″b″ and ″c″, and/or ″a″, ″b″, and ″c″.

As may also be used herein, the terms ″processing module″, ″processing circuit″, ″processor″, ″processing circuitry″, and/or ″processing unit″ may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a ″start″ and/or ″continue″ indication. The ″start″ and ″continue″ indications reflect that the steps presented can optionally be incorporated in or otherwise used in conjunction with one or more other routines. In addition, a flow diagram may include an ″end″ and/or ″continue″ indication. The ″end″ and/or ″continue″ indications reflect that the steps presented can end as described and shown or optionally be incorporated in or otherwise used in conjunction with one or more other routines. In this context, ″start″ indicates the beginning of the first step presented and may be preceded by other activities not specifically shown. Further, the ″continue″ indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term ″module″ is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human ″artificial″ intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition — requires ″artificial″ intelligence — i.e., machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event —without any intervening human interaction between the triggering event and the action. Any such actions may be identified as being performed ″automatically″, ″automatically based on″ and/or ″automatically in response to″ such a triggering event. Furthermore, any such actions identified in such a fashion specifically preclude the operation of human activity with respect to these actions — even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method executable by an item data extraction and management computing entity of a multi-access point item data extraction and management system, the method comprises:
identifying, by the item data extraction and management computing entity, one or more active item data access points of a plurality of data access points of a computing device of the multi-access point item data extraction and management system, wherein the computing device is associated with the item data extraction and management computing entity via an item data extraction and management interface;
determining, by the item data extraction and management computing entity, whether to extract item data from the one or more active item data access points;
when it is determined to extract the item data:
identifying, by the item data extraction and management computing entity, relevant item data available from the one or more active data access points;
extracting, by the item data extraction and management computing entity, the relevant item data from the one or more active data access points;
parsing, by the item data extraction and management computing entity, the relevant item data to produce parsed item data;
analyzing, by the item data extraction and management computing entity, the parsed item data to produce interpreted item data;
storing, by the item data extraction and management computing entity, one or more of the relevant, parsed, and interpreted item data in one or more databases of the multi-access point item data extraction and management system.

2. The method of claim 1, wherein the identifying the one or more active item data access points comprises:
monitoring, by the item data extraction and management computing entity, actions of the computing device; and
when an action of the actions is a triggering action:
determining, by the item data extraction and management computing entity, an active data access point of the one or more active data access points related to the triggering action.

3. The method of claim 1, wherein the determining whether to extract the item data comprises one or more of:
obtaining, by the item data extraction and management computing entity, a user input; inspecting, by the item data extraction and management computing entity, data from the one or more active data access points;
determining, by the item data extraction and management computing entity, whether the active data access point is associated with stored item data; and
determining, by the item data extraction and management computing entity, one or more user preferences.

4. The method of claim 1, wherein the identifying the relevant item data comprises one or more of:
inspecting, by the item data extraction and management computing entity, the one or more active data access points for relevant item data based on one or more of: known relevant item data and one or more data access point data models;
processing, by the item data extraction and management computing entity, image data from the one or more active data access points; and
obtaining, by the item data extraction and management computing entity, a user input regarding the relevant item data.

5. The method of claim 1, wherein the extracting the relevant item data from the one or more active data access points comprises one or more of:
smart scraping, by the item data extraction and management computing entity, the relevant item data from the one the one or more active data access points; and
analyzing, by the item data extraction and management computing entity, image item data.

6. The method of claim 1, wherein the analyzing the parsed item data to produce interpreted item data comprises one or more of:
adding metadata to the parsed item data; and
adding, by the item data extraction and management computing entity, one or more tags to the parsed item data.

7. The method of claim 1, wherein the storing the one or more of the relevant, parsed, and interpreted item data in one or more databases comprises one or more of:
storing, by the item data extraction and management computing entity, the one or more of the relevant, parsed, and interpreted item data in a shared database of the one or more databases;
storing, by the item data extraction and management computing entity, the one or more of the relevant, parsed, and interpreted item data in a private user database of the one or more databases; and
storing, by the item data extraction and management computing entity, the one or more of the relevant, parsed, and interpreted item data in a general database of the one or more databases.

8. The method of claim 1 further comprises:
indexing, by the item data extraction and management computing entity, the parsed item data to produce indexed, parsed item data.

9. A multi-access point item data extraction and management system comprises:
an item data extraction and management computing entity;
a computing device of a plurality of computing devices, wherein the computing device includes a plurality of data access points, wherein the computing device is associated with the item data extraction and management computing entity via an item data extraction and management interface; and
one or more databases operably coupled to the item data extraction and management computing entity, wherein the item data extraction and management computing entity includes:
a data extraction module operable to:
identify one or more active item data access points of the plurality of data access points;
determine whether to extract item data from the one or more active item data access points;
identify relevant item data available from the one or more active data access points;
extract the relevant item data from the one or more active data access points; and
a data processing module operable to:
parse the relevant item data to produce parsed item data;
analyze the parsed item data to produce interpreted item data; and
a database interface module operable to:
store one or more of the relevant, parsed, and interpreted item data in the one or more databases.

10. The multi-access point item data extraction and management system of claim 9, wherein the data extraction module is operable to identify the one or more active item data access points by:
monitoring actions of the computing device; and
when an action of the actions is a triggering action:
determining an active data access point of the one or more active data access points related to the triggering action.

11. The multi-access point item data extraction and management system of claim 9, wherein the data extraction module is operable to determine whether to extract the item data by one or more of:
obtaining a user input;
inspecting data from the one or more active data access points;
determining whether the active data access point is associated with stored item data; and
determining one or more user preferences.

12. The multi-access point item data extraction and management system of claim 9, wherein the data extraction module is operable to identify the relevant item data by one or more of:
inspecting the one or more active data access points for relevant item data based on one or more of: known relevant item data and one or more data access point data models;
processing image data from the one or more active data access points; and
obtaining a user input regarding the relevant item data.

13. The multi-access point item data extraction and management system of claim 9, wherein the data extraction module is operable to extract the relevant item data from the one or more active data access points by one or more of:
smart scraping the relevant item data from the one the one or more active data access points; and
analyzing image item data.

14. The multi-access point item data extraction and management system of claim 9, wherein the data processing module is operable to analyze the parsed item data to produce interpreted item data by one or more of:
adding metadata to the parsed item data; and
adding one or more tags to the parsed item data.

15. The multi-access point item data extraction and management system of claim 9, wherein the database interface module is operable to storing the one or more of the relevant, parsed, and interpreted item data in one or more databases comprises by or more of:
storing the one or more of the relevant, parsed, and interpreted item data in a shared database of the one or more databases;
storing the one or more of the relevant, parsed, and interpreted item data in a private user database of the one or more databases; and
storing the one or more of the relevant, parsed, and interpreted item data in a general database of the one or more databases.

16. The multi-access point item data extraction and management system of claim 9, wherein the data extraction module is further operable to:
index the parsed item data to produce indexed, parsed item data.
